(19) United States
(12) Patent Application Publication
(10) Pub. No.: US 2005/0256295 A1
(43) Pub. Date: Nov. 17, 2005

(54) Polymer compound, highly transparent polyimide, resin composition and article

(76) Inventor: Katsuya Sakayori, Tokyo (JP)

Correspondence Address: SEYFARTH SHAW LLP, 55 EAST MONROE STREET, SUITE 4200, CHICAGO, IL, 60603-5803, US

(21) Appl. No.: 11/093,783

(22) Filed: Mar. 30, 2005

(30) Foreign Application Priority Data
Mar. 31, 2004 (JP) 2004-107174

(51) Int. Cl. C08G 69/08

(52) U.S. Cl. 528/310

(57) ABSTRACT

A polymer compound, wherein a transparency of a polymer compound which is easily colored due to the formation of a conjugated state is improved by a new method different from conventional ones, is provided. More preferably, polyimide having high transparency and original properties such as heat resistance or the like at the same time is provided.
A polymer compound comprising a part which sequences an unsaturated bond containing a n electron orbit and a single bond alternately, wherein at least a part of a conjugated state formed by the n electron orbit in a molecule is shortened or weakened due to a three-dimensional structure of the molecule, thereby a transmittance is improved, is provided. Further, as one embodiment thereof, highly transparent polyimide having a repeating unit represented by the following formula (1) is provided: 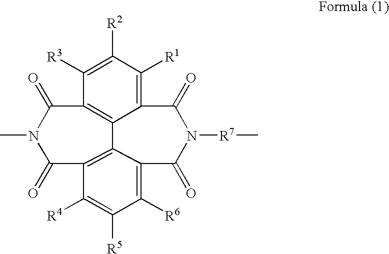
wherein, each of R¹ to R⁶ is independently a hydrogen atom or a monovalent organic group, and which may be bonded each other; R⁷ is a divalent organic group.

### BACKGROUND OF THE INVENTION

1. Field of the Invention

The present invention relates to a polymer compound excellent intransparency, and preferably to polyimide excellent in heat resistance and transparency. More particularly, the present invention relates to a polyimide suitably utilized as a material for forming a product or a member requiring high transparency together with heat resistance (for example, an optical product, a molding material of optical parts, a layer-forming material, an adhesive or the like), a resin composition containing the polyimide, and an article produced by using the resin composition.

2. Description of the Related Art

Polymer material is used for various familiar products due to its properties such as high processability, lightness in weight or the like. Polyimide developed by DuPont, U.S., in 1955 has been further developed so as to apply to an aerospace field or the like because of its excellent heat resistance. Since then, in detailed studies done by many researchers, it was found that properties such as heat resistance, dimensional stability, insulating property and the like are good among organic matters showing top-class properties, hence, polyimide has been applied not only to the aerospace field but also to an insulating material of electronic parts and the like. Nowadays, polyimide is increasingly utilized as a chip coating layer of a semiconductor element, a substrate of a flexible printed-wiring board and the like.

Polyimide is a polymer which is synthesized from diamine and acid dianhydride. Precursor of polyimide (polyamic acid) is obtained by reacting diamine and acid dianhydride in liquid. Then, polyimide can be obtained through a dehydration and ring-closure reaction. Generally, as polyimide is poor in solubility to a solvent and difficult to process, polyimide is often obtained by making its precursor, which is polyamic acid, into desired form followed by heating. Polyamic acid decomposes by heat or water, thus, it is not good in storage stability. Taking the point into consideration, polyimide, which is obtained by introducing a structure excellent in solubility to a molecular structure to obtain polyimide followed by improvement so as to be solved to a solvent to form or apply, has been developed. However, this polyimide tends to be inferior in chemical resistance or adhesion to a substrate to polyimide obtained by the means using a precursor. Hence, either means using a precursor or means using solvent-soluble polyimide is used according to purpose.

In recent years, in growing market of thin displays represented by liquid crystal and plasma displays, researches are pursued to make these thin displays deformable and flexible. Particularly, organic EL displays or the like expected as next-generation thin displays is also expected to make the organic EL displays flexible since light emitting portions of the EL displays are made of organic materials.

In order to put these flexible displays to practical use, an attempt is made to change glass currently used as a substrate to polymer which is a flexible material being able to be bent. Transparency, heat resistance, chemical resistance, barrier property of water vapor or oxygen, dimensional stability and the like equal to glass are required to such a replacing material.

As the replacing material of glass, the higher heat resistance is better, however, from the viewpoint of required heat-treatment condition at a post-process, it is preferable that a glass transition temperature is at least 200 ° C. or more. As for a transparency, a material having no absorption is ideal, however, it is considered that a material at least having a transmittance of 85% or more at each wavelength in wavelength range of 400 nm to 800 nm generally recognized as the visible light range is preferable. Also, it is said that dimensional stability is preferably in order of several ppm equivalent to glass, however, it is considered to be preferable that the material has 40 ppm or less at least.

Besides the substrates of flexible displays, considerations and proposals are pursued to change products conventionally using glass such as optical fiber, lens or the like, or portions wherein glass is suitably used in the present circumstances such as members used for optical waveguides or optical circuits, optical elements, surface protection films of optical elements or the like, to a polymer material.

Since polyimide resin has high heat resistance, is light weighted and has high strength, it is one of materials considered to be a replacing material of glass from early on, however, there are still some problems to be solved.

Transparency is one of the problems. Polyimide is generally colored in sienna. The reason is said to be charge transfer. Recently, it is reported that particularly charge transfer in a molecule is highly related to coloring (Polymer Preprints, Japan 48 [5] 939 (1999)).

That is, transparent polyimide can be formed by eliminating charge transfer in the molecule. Based on this principle, as conventional means to increase transparency of polyimide, two major means are proposed.

One means is to increase transparency by introducing an aliphatic structure, particularly alicyclic structure, to a polyimide structure in which there are normally many aromatic structures to shorten conjugation of n electron in the structure so as to inhibit charge transferin the structure. Particularly, it is disclosed to be effective to introduce an alicyclic structure to diamine which is a starting material (Polymer Preprints, Japan 48 [5] 939 (1999), and Japanese Patent Application Laid-Open (JP-A) No. Hei. 10-310639).

The other means is to provide transparency by introducing fluorine in a polyimide structure so as to hinder charge transfer in an electronic state of the structure (JP-A No. Hei. 05-1148).

As for polyimide using 2,2′,6,6′-biphenyltetracarboxylic dianhydride as an acid component, Goin et al., U. S., discloses in POLYMER LETTERS Vol.6, p. 821-825 (1968) that after refining polyamic acid obtained by reacting 2,2′,6,6′-biphenyltetracarboxylic dianhydride with 4,4′-diamino diphenyl ether in dimethylacetamide by reprecipitation using diethyl ether, polyamic acid liquid obtained by being solved again in dimethylacetamide is cast, followed by heating gradually up to 300° C., and thus obtained polyimide. The thermally decomposing temperature of polyimide is merely disclosed herein, but other physical properties are not stated in detail.

Also, JP-A No. Sho. 56-52722 similarly discloses to utilize polyimide synthesized by using 2,2′,6,6′-biphenyltetracarboxylic dianhydride and 4,4′-diamino diphenyl ether as a liquid crystal orientation layer, however, an ability to orient a liquid crystal is merely disclosed herein, but other physical properties are not disclosed.

In Example of JP-A No. Hei. 6-41205 polyimide using 2,2′,6,6′-biphenyltetracarboxylic dianhydride is disclosed, however, the polyimide is used as a protective layer which prevents polymer to adhere to a polymerization container. It is mentioned about a primary coloring of the polymer produced in the polymerization container having the protective layer provided, however, physical properties of polyimide are not stated at all.

JP-A No. Hei. 6-329799 discloses a method for producing a molded body of polyimide and 2,2′,6,6′-biphenyltetracarboxylic dianhydride is mentioned as one representative example of a starting material, however, compound names are merely listed without actual synthesis examples, thus, no specific physical properties can be learned.

JP-A No. Hei. 11-140181 discloses a method for producing polyimide microparticles and 2,2′,6,6′-biphenyltetracarboxylic dianhydride is mentioned herein as a representative example of a starting material, however, compound names are merely listed without actual synthesis examples, thus, no specific physical properties can be learned.

JP-A No. 2002-60489 discloses polyimide and an adhesive tape obtained using the same. 2,2′,6,6′-biphenyltetracarboxylic dianhydride is also mentioned herein as a representative example of a material, however, compound names are merely listed without actual synthesis examples, thus, no specific physical properties can be learned.

JP-A No. Hei. 3-275725 discloses a method for producing a photoconductive polymer. 2,2′,6,6′-biphenyltetracarboxylic dianhydride is also mentioned herein as a representative example of a material, however, compound names are merely listed without actual synthesis example, thus, no specific physical property can be learned.

All of the above mentioned conventional means for improving transparency of polyimide accordingly induce decrease in physical properties.

The first means has a problem that an alicyclic structure tends to be more easily oxidized than an aromatic structure, thus colored by oxidization when heated in air. Hence, it is recommended to heat polyimide having an alicyclic structure introduced under inert atmosphere. Also, the polyimide having an alicyclic structure introduced has a lower thermally decomposing temperature than the aromatic polyimide, thus, it is inferior in heat resistance. Further, in the case of raising the coefficient of linear thermal expansion and forming an interface with a substance having the small thermal expansion coefficient such as metal, metal oxide, silicon wafer or the like, a warpage may be generated or a deterioration in adherence may be caused due to a heat history.

Also, in the case of using diamine having an alicyclic structure as a starting material, diamine having an alicyclic structure has higher basicity than aromatic diamine, thus, when a polymerization reaction is performed with acid dianhydride, a salt is formed with carboxylic acid of polyamic acid produced, thus, it becomes difficult to increase a molecule weight. Therefore, a silylation method (a method to sililate an amino group and then to polymerize with acid dianhydride) or the like is proposed, however, increase of one synthesis process causes increase in cost.

On the other hand, the second means has a problem that by introducing fluorine to polyimide, cost of a material rises leading to increase in cost. Also, introducing fluorine causes decrease in adhesion of an interface, thus it becomes easy to be peeled from a substrate. Also, solvent resistance declines, and the glass transition temperature also lowers. Further, as the coefficient of linear thermal expansion becomes larger, a warpage of a substrate or decrease in adhesion may be caused when forming is performed on a substrate having a small thermal expansion coefficient.

### SUMMARY OF THE INVENTION

The present invention has been achieved in light of the above-stated conventional problems. A first object of the present invention is to provide a polymer compound which can be colored easily due to a part which sequences an unsaturated bond containing a n electron orbit and a single bond alternately, for example, a polymer compound obtained by improving a transparency of a polymer compound of which an aromatic structure makes up a large portion such as an aromatic polyimide by a new method different from conventional ones, and a resin composition useful as a resin material for forming a product or a member requiring high transparency using the polymer compound, further, a product or a member excellent in transparency produced by using the resin composition.

A second object of the present invention is to provide polyimide having high transparency and keeping original properties of polyimide such as heat resistance or the like.

A third object of the present invention is to provide a polyimide resin composition useful as a resin material for producing a product or a member requiring high transparency besides heat resistance with the use of the polyimide having a high transparency.

A fourth object of the present invention is to provide a product or a member excellent in heat resistance and transparency, or a replacing material of glass which is light and can be flexible with the use of the polyimide resin composition.

The present invention is to solve at least one of the above objects.

A polymer compound of the present invention to solve the aforementioned problems comprises a part which sequences an unsaturated bond containing a n electron orbit and a single bond alternately, wherein at least a part of a conjugated state formed by the n electron orbit in a molecule is shortened or weakened due to a three-dimensional structure of the molecule, and wherein a transmittance of at least a part of a wavelength between 400 nm to 800 nm is larger than an expected transmittance provided that the conjugated state is not shortened or weakened.

A polymer compound comprising a part which sequences an unsaturated bond containing a n electron orbit and a single bond alternately generally tends to have a conjugated state formed by a n electron orbit in a molecule. However, the polymer compound of the present invention has the conjugated state, which will be generally formed, been shortened or weakened due to a three-dimensional structure in a molecule, thus, stabilization of a n electron orbit is inhibited. As a result, an absorption wavelength region of light is made to be a short wavelength so as to improve a transmittance of light having a wavelength in a visible light region.

As one embodiment of the polymer compound of the present invention, there may be a polymer compound wherein 50 wt % or more of the whole polymer compound is composed of an aromatic structure, and wherein a transmittance of each wavelength between 400 nm and 800 nm when the polymer compound is made into a film having a thickness of 1 μm is 85% or more.

A polymer compound wherein 50 wt % or more of the whole polymer compound is composed of an aromatic structure is generally a typical example of a polymer compound which tends to have a conjugated state formed by a n electron orbit in a molecule, and is a molecular structure easy to be colored. However, in the present invention, the conjugated state, which is generally formed, is shortened or weakened by a three-dimensional structure in a molecule, therefore, a transmittance of light having a wavelength in a visible light region can be improved.

Specifically, the polymer compound of the present invention can attain a highly excellent transparency wherein a transmittance of each wavelength between 400 nm to 800 nm when the polymer compound is made into a film having a thickness of 1 μm is 85% or more.

Next, a resin composition of the present invention contains the polymer compound of the present invention. The resin composition can be utilized for all fields and products in which a resin material is conventionally used such as pattern forming materials (resists), coating materials, paints, printing inks, adhesives, fillers, electronic materials, molding materials, resist materials, building materials, 3D modelings, flexible display films, optical members or the like.

Particularly, since the resin composition of the present invention has a high transparency, it is suitable for forming products of fields in which these properties are advantageous, for example, paints, printing inks, color filters, flexible display films, electronic parts, layer insulation films, wire cover films, optical circuits, optical circuit parts, antireflection films, holograms, other optical members or building materials.

Also, a highly transparent polyimide of the present invention is one of the suitable polyimide among polymer compounds of the present invention, and has a repeating unit represented by the following formula (1): 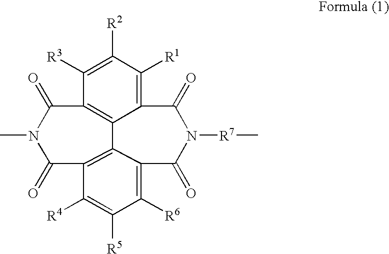
wherein, each of R¹ to R⁶ is independently a hydrogen atom or a monovalent organic group, which may be bonded each other; R⁷ is a divalent organic group; and groups represented by the same symbol among repeating units in the same molecule may be different atoms or structures.

An imide structure contained in the repeating unit represented by the formula (1) is unstable when arranged in a plane, thus, a relative position of a benzene ring of a biphenyl structure contained in the imide structure kinks and a conjugation of a n bond is shortened.

Since the polyimide of the present invention has such a space configuration of a molecular structure, the polyimide holds a heat resistance due to a characteristic of aromatic polyimide and a charge transfer on a polyimide molecular chain is inhibited so as to obtain transparent polyimide.

Next, a polyimide resin composition of the present invention contains the polyimide of the present invention. The polyimide resin composition can be utilized for all fields and products in which a resin material is conventionally used such as pattern forming materials (resists), coating materials, paints, printing inks, adhesives, fillers, electronic materials, molding materials, resist materials, building materials, 3D modelings, flexible display films, optical members or the like.

Particularly, since the polyimide resin composition of the present invention has a high transparency in addition to original properties of polyimide such as heat resistance, dimensional stability, insulation or the like, it is suitable for forming products of fields in which these properties are advantageous, for example, paints, printing inks, color filters, flexible display films, electronic parts, layer insulation films, wire cover films, optical circuits, optical circuit parts, antireflection films, holograms, other optical members or building materials.

As aforementioned, the polymer compound of the present invention has a part which sequences an unsaturated bond containing a n electron orbit and a single bond alternately, thus, a conjugated state which tends to be formed in the polymer is shortened or weakened by a three-dimensional structure of a molecule. As a result, excellent transparency can be attained. In such a manner, excellent transparency can be obtained without declining useful original properties of the polymer compound in comparison with increasing transparency by introducing other chemical structures or substituents in the molecule.

Therefore, the polymer compound of the present invention is useful as a resin material for forming a product or a member requiring high transparency with the use of the polymer compound, and is possible to produce a product or a member excellent in transparency with the use of the resin composition containing the polymer compound.

Also, the polyimide of the present invention exhibits good transparency without introducing fluorine or an alicyclic structure. Hence, conventionally unavoidable problems due to the introduction of fluorine or an alicyclic structure such as lowering of original physical properties of polyimide such as heat resistance, dimensional stability or the like, and rise of cost can be solved. In addition, a coating layer, film or molded article of the polyimide having a heat resistance equal to conventional aromatic polyimide and a high transparency can be obtained.

Since the resin composition containing the polyimide of the present invention has high transparency in addition to heat resistance, dimensional stability and insulation, the resin composition is suitable for all known films for member or coating layers requiring transparency. For example, the resin composition is expected to be utilized as a film or structure having high heat resistance for an optical member such as an antireflection film, an optical circuit part, a hologram or the like.

Further, the polyimide resin composition is highly expected to be utilized for a substrate of an optical member such as a substrate for a thin display of, for example, a liquid crystal display, an organic EL or the like as a glass replacing material which is light and can be flexible.

### BRIEF DESCRIPTION OF THE DRAWINGS

In the accompanying drawings,

FIG. 1 is a three-dimensional structure model of a compound having a structure represented by the formula (1);

FIG. 2 is a graph showing the result of transmittance measured at a range of 400 to 800 nm in each coating layer of polyimide 2, 4 and 5 and a precursor liquid 1 synthesized in Example; and

FIG. 3 is a graph showing the result of a dynamic viscoelasticity measurement in each film of polyimide 2 and 4 synthesized in Example.

### DETAILED DESCRIPTION OF THE INVENTION

Hereinafter, the embodiment of the present invention will be explained in more detail. The inventor has performed a molecular design of polyimide based on a totally novel concept. As a result, aromatic polyimide having high heat resistance, particularly preferably polyimide having high transparency and being wholly aromatic polyimide without introducing fluorine has been invented. That is, a concept to shorten a conjugated structure of a n electron of a molecular chain of polyimide by giving a twist to the structure in order to avoid a charge transfer on the polyimide molecular chain, which causes coloring, is applied to polyimide.

Further, the present invention has been lead in the study of the inventor that the above-mentioned concept is not limited to polyimide but can be widely applied to a polymer compound comprising a part which sequences an unsaturated bond containing a n electron orbit and a single bond alternately, and thereby a conjugated state is formed in a molecule to cause coloring.

A polymer compound of the present invention based on the above concept is a polymer compound comprising a part which sequences an unsaturated bond containing a n electron orbit and a single bond alternately, wherein at least a part of a conjugated state formed by the II electron orbit in a molecule is shortened or weakened due to a three-dimensional structure of the molecule, and wherein a transmittance of at least a part of a wavelength between 400 nm to 800 nm is larger than an expected transmittance provided that the conjugated state is not shortened or weakened.

Since the polymer compound of the present invention has a part which sequences an unsaturated bond containing a n electron orbit and a single bond alternately, under normal circumstances, a conjugated state is easily formed by a n electron orbit in a molecule and an electron orbit is stabilized, thereby, absorption tends to be exhibited at an electromagnetic wave of a long wavelength and it is easy to be colored.

In general, a n conjugated structure can be found when unsaturated bonds are linked disposing a single bond therebetween. In that case, the single bond has a double bond-like property due to an interaction between unsaturated bonds. An electron (n electron) concerned in the n bond of the unsaturated bonds linked via the single bond is stabilized by having a common n electron orbit. Hence, electrons including an electron which is present on a bond originally of a single bond are in the same plane.

The unsaturated bond in this a case is not limited to a bond between carbon atoms but also includes a hetero atom such as a carbonyl group or the like.

Further, in the broad sense, a n conjugated structure, an unsaturated bond of which is linked with a functional group comprising an atom having a noncovalent electron pair such as an amino group, an ether group or the like, may be exemplified.

The present invention is applicable to all structures having a n conjugated structure heretofore known including the above-mentioned examples.

As a typical example of the n conjugated structure, there may be an aromatic structure. An aromatic structure of the present invention means a chemical structure generally defined as an aromatic series including an aromatic cyclic structure in which unsaturated bonds in the structure are linked in a cyclic form and n-conjugated to form a planar structure such as benzene or naphthalene.

In the present invention, at least a part of the conjugated state which would be normally formed by a n electron orbit present in the molecule of the polymer compound is shortened or weakened by a three-dimensional structure of the molecule. Herein, the part in which a conjugated state would be normally formed is a part in which a double bond containing a n bond and a single bond including only an a bond are sequenced alternately when a planar primary structural formula of a polymer compound is drawn.

In this manner, stabilization of the n electron orbit present in the molecule of the polymer compound is inhibited by shortening or weakening of at least a part of the conjugated state which would be normally formed. That is, a charge transfer in the molecule caused by the unification of the n electron orbit is inhibited.

The three-dimensional structure in the present invention includes both conformation and configuration of a molecule. The conformation means a spatial arrangement of an atom or atomic group bonded to an asymmetric carbon atom around the asymmetric carbon atom, or a spatial arrangement of an atom or atomic group bonded to a structure not free of moving in a molecule around the structure, for example, a cis-trans isomer. The configuration means various spatial arrangements of atoms in a molecule which is attained by rotation of two atomic groups linked by one single bond in the molecule used as an axis.

Shortening or weakening of a n conjugated structure described in the present invention means that an interaction of n electron orbits becomes not capable or difficult due to the effect of sterichindrance wherein normally unsaturated bonds are linked via a single bond so as to form a conjugated structure.

Specifically, it means the state that two n electron orbits of unsaturated bonds located at both ends of a single bond are not in the same plane. Generally, as an angle of the planes approaches from 0° to 90°, an interaction becomes difficult to be exhibited. When the angle reaches 90°, it is considered to be most difficult to perform the interaction.

Generally, it is considered that when two n electron orbits are on the same plane, the interaction is most capable and they are stable, and when two n electron orbits cross at right angles, the interaction is most tenuous and they are unstable. The stable electron orbit is excited by an electromagnetic wave of low energy, i.e. an electromagnetic wave of long wavelength, thus absorption is large in that part. That is, the larger the degree of inhabitation is against stabilization of the n electron orbit, the further the absorption wavelength shifts to a short wavelength side compared to the original absorption wavelength.

Herein, the effect of steric hindrance means that a tendency or driving force which forms a n plane, that is, a conjugated state, in order to stabilize or unify adjacent two or more n electron orbits due to a three-dimensional structure of a molecule and a tendency or driving force which increases stability of a conformation due to causes other than the stabilization of the II electron orbit compete against each other at a common position in the molecular structure so that the formation of the n plane is totally inhibited or the n plane is distorted.

As a cause of the steric hindrance, there maybe, for example, a distortion of a cyclic structure or a spatial hindrance due to a relatively large substituent.

In the case of highly transparent polyimide containing a seven-membered ring imide structure to be hereinafter described, a driving force to release a distortion of an imide ring is stronger than a driving force to arrange two benzene rings contained in a biphenyl structure unified with the imide ring on the same n plane. As a result, a conjugation of a n bond is shortened.

Also, 2,2′-dimethyl-4,4′-diaminobiphenyl is difficult to be conjugated in comparison with 4,4′-diaminobiphenyl to which a methyl group is not introduced since a free rotation of a single bond between benzene rings is inhibited by two methyl groups introduced at the 2-position and 2′-position.

Whether a conjugated state in a molecule of a polymer compound will be shortened or weakened by a three-dimensional structure of the molecule can be presumed from the result of a molecular orbital calculation of the polymer compound or a similar model compound.

As aforementioned, a conjugated state of a polymer compound is shortened or weakened, thus, a light absorption wavelength range of the polymer compound is made to be a short wavelength so that a light transmittance of a wavelength in a visible light range can be improved.

Herein, whether the light absorption wavelength range is shifted to a short wavelength side can be confirmed by comparing an approximate value of an absorption wavelength range and/or a strength which may be presumed from a calculation of a molecular mechanics or molecular orbital such as MM2, AM1 and PM5 of the polymer compound or the similar model compound and the actual measurement value thereof. If there is no compound to compare, a confirmation will suffice if at least a state in which a n conjugated structure is shortened and/or weakened is a most stable structure according to the calculation of a molecular mechanics and a molecular orbit.

As other means, an absorption wavelength of a compound a conjugated structure of which is shortened or weakened may be compared to confirm with that of a model compound when the model compound of a similar structure, in which a conjugated structure continues, stably exists.

In the present invention, an excellent transparency can be obtained without declining useful properties in which a polymer compound originally has in comparison with in the case of increasing a transparency by introducing other chemical structures or substituents in a molecule.

It is preferable that a light transmittance of the polymer compound of the present invention is improved at all wavelength of a visible light range (400 nm to 800 nm) or a total light transmittance of the polymer compound of the present invention is improved by a principle of improving transparency of the present invention. However, depending on a use of the polymer compound or a wavelength of a light source used in the use, it is sufficiently useful if a light transmittance rises at a part of a wavelength between 400 nm to 800 nm. Hence, in the present invention, it is acceptable if at least a part of a light transmittance of a wavelength between 400 nm to 800 nm is improved by a three-dimensional structure of a molecule wherein a conjugated state in the polymer compound is shortened or weakened.

If an aromatic structure, which is a typical example of a n conjugated structure, is abundantly contained in a molecule of a polymer compound, a n conjugated chain of each aromatic structure tends to be unified to form more stable conjugated state. The present invention is also significantly effective to such a polymer compound.

Specifically, a polymer compound, wherein 50 wt % or more of the whole molecular structure is an aromatic structure, is normally a typical example of a compound in which a conjugated state is easily formed by a n electron orbit in a molecule, and is a molecular structure easy to be colored. However, the polymer compound of the present invention can attain a highly excellent transparency so that a transmittance between 400 nm to 800 nm in each wavelength is 85% or more, more preferably 90% or more when a film having a thickness of 1 um, preferably 2 μm, more preferably 2 μm or more, is formed even if 50 wt % or more of the whole molecular structure is an aromatic structure. It is further preferable that a total light transmittance (JIS K7105) of the film is 90% or more.

Herein, “50 wt % or more of the whole aromatic structure” means that a ratio of weight of a constitutional unit forming an aromatic structure in a polymer is 50% or more in the total weight of the polymer. The constitutional unit of an aromatic structure comprises an atom having a n electron concerned in an unsaturated bond forming an aromatic structure and a hydrogen atom or a halogen atom bonded directly to the atom. Specifically, for example, in the case of xylene having a chemical structure of CH₃—C₆H₄—CH₃, C₆H₄ is an aromatic structure.

A means to confirm whether 50 wt % or more of the whole is an aromatic structure is not particularly limited. For example, a means such as a ¹H- and ¹³C-NMR spectrum (nuclear magnetic resonance spectrum) of a solid or liquid, an infrared spectrum, a gas chromatography or the like can be used.

In order to sufficiently obtain an effect of improvement in transparency, it is preferable that the polymer compound of the present invention contains 50% or more, more preferably 70% or more, in mole ratio, of a three-dimensional structure of the molecule which shortens or weakens a conjugated state with respect to an amount of an aromatic ring being a part of a polymer frame or a repeating unit containing a condensed ring including an aromatic ring.

In the case of containing plural aromatic rings as a part of a polymer frame, a conjugated state is highly likely to be formed in a molecule, hence, a profit obtainable by improving transparency by applying the present invention thus increases.

From the viewpoint, as one preferable embodiment of the present invention, there may be a polymer compound wherein 50% by mole or more, particularly 70% by mole or more, of a repeating unit constituting a polymer frame is a repeating unit containing an aromatic ring or a condensed ring including an aromatic ring to be apart of the polymer frame, and at least apart of a conjugated state between the aromatic rings or the condensed rings to be a part of the polymer frame is shortened or weakened by a three-dimensional structure of a molecule.

Herein, the repeating unit constituting a polymer frame includes a repeating unit of both principal chain structure and side chain structure. Particularly, it is preferable that the above condition is met when limited to the repeating unit constituting a principal chain structure.

The aromatic ring contained in a repeating unit may be an aromatic ring having a monocyclic structure or an aromatic ring having a condensed polycyclic structure. Also, the condensed ring including an aromatic ring may contain two or more aromatic rings. The aromatic ring included in the condensed ring may be a monocyclic structure or a condensed polycyclic structure.

A mole ratio may be determined by dividing the repeating unit into a minimum repeating unit if the repeating unit can be further divided into two or more repeating units.

As a preferable embodiment of the present invention, there may be a polymer compound wherein the polymer compound contains two or more aromatic rings as a repeating unit constituting a polymer frame (polymer skeleton), more preferably a principal chain structure, and a conjugated state between aromatic rings of the repeating unit is shortened or weakened by a three-dimensional structure of a molecule.

In this embodiment, 50% by mole or more, more preferably 70% by mole or more, of a repeating unit constituting a polymer frame, more preferably a principal chain structure, is preferably a repeating unit in which a conjugated state between aromatic rings is shortened or weakened by a conformation of a molecular structure.

If a condensed ring to be a part of a polymer frame contains two or more aromatic rings, transparency of a polymer compound can be effectively improved by shortening or weakening a conjugated state between aromatic rings contained in the same condensed ring by a three-dimensional structure in a molecule.

That is, as another preferable embodiment of the present invention, there may be a polymer compound containing a repeating unit containing a condensed ring to be a part of a polymer frame and a conjugated state between at least two aromatic rings contained in the same condensed ring of the repeating unit is shortened or weakened by a three-dimensional structure of a molecule. Highly transparent polyimide containing a seven-membered ring imide structure to be hereinafter described is one of the kinds of this embodiment.

In this embodiment, it is more preferable that 50% by mole or more, particularly 70% by mole or more, of a repeating unit constituting a polymer frame, more preferably a principal chain structure, is the repeating unit containing a condensed ring containing two or more aromatic rings in which a mutual conjugated state is shortened or weakened.

Aforementioned polymer compound of the present invention is useful as a resin material for forming a product or member requiring high transparency using the polymer compound, and can produce a product or member excellent in transparency using a resin composition containing the polymer compound.

Hereafter, as one example of a polymer compound of the present invention, highly transparent polyimide containing a seven-membered ring imide structure is described in detail. Features, advantages and other contents to be hereafter explained regarding the highly transparent polyimide are common explanations for the polymer compound of the present invention in general, unless it is not particularly inconsistent.

Highly transparent polyimide of the present invention has a repeating unit containing a seven-membered ring imide structure represented by the following formula (1): 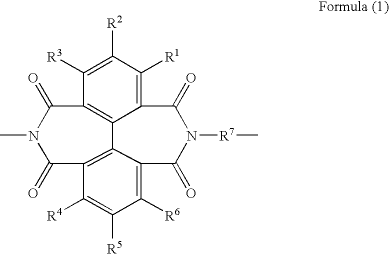
wherein, each of R¹ to R⁶ is independently a hydrogen atom or a monovalent organic group, which may be bonded each other; R⁷ is a divalent organic group; and groups represented by the same symbol among repeating units in the same molecule may be different atoms or structures.

A conjugated structure of a n electron of each of polyimide having a five-membered ring imide structure represented by polyimide derived from pyromellitic dianhydride and polyimide having an aromatic six-membered ring imide structure represented by polyimide derived from 1,4,5,8-naphthalene tetracarboxylic dianhydride tends to spread over a molecular chain of polyimide as all atoms concerned in an imide bond are stably arranged in a plane like form. Particularly, in the case of wholly aromatic polyimide using not only aromatic acid dianhydride as an acid component but also aromatic diamine as a diamine component, the conjugated structure is more likely to spread over the molecular chain of polyimide in wide range, thus, it is more likely to cause a coloring phenomenon.

Also, polyimide derived from 3,3′,4,4′-biphenyltetracarboxylic dianhydride has imide groups bonded to a different benzene ring but has an imide group of a five-membered ring structure having a planar structure, therefore, the benzene ring and the imide group are n-conjugated. Also, a single bond which bonds two benzene rings derived from acid anhydride can freely rotate, thus, the benzene rings can form a n-conjugated structure.

On the contrary, the polyimide of the present invention has an imide structure contained in a repeating unit represented by the formula (1), that is, 2,2′,6′,6′-biphenyltetracarboxylic dianhydride or a seven-membered ring imide structure derived from a compound having a substituent on aromatic ring of 2,2′,6′,6′-biphenyltetracarboxylic dianhydride, and is unstable when arranged in a plane. Hence, a relative position of a benzene ring of a biphenyl structure contained in the imide structure is twisted so that a conjugation of an bond is shortened.

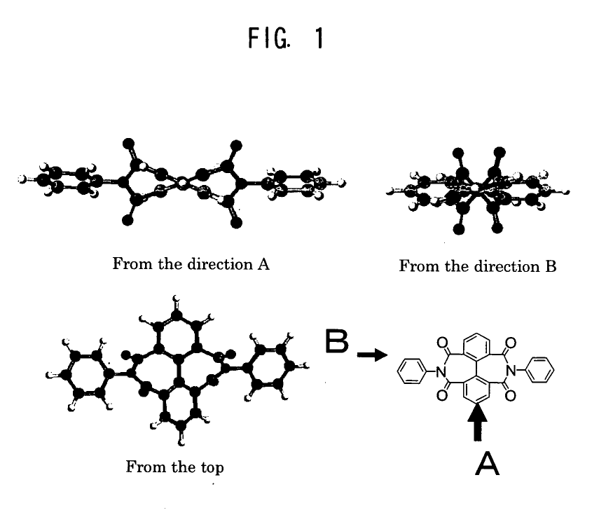

FIG. 1 shows a spatial arrangement presumed from the result of a calculation of a molecular orbital of a model compound having a structure represented by the formula (1). Since a bond of 2,2′,6′,6′-biphenyltetracarboxylic dianhydride which bonds benzene rings of the biphenyl structure can rotate, when an imidization is performed, a seven-membered ring imide structure is formed. Thus, it is assumed from the result of the calculation of MM2 molecular orbital that two benzene rings and an imide bond are not present in the same plane but in an inclined conformation wherein benzene rings are inclined each other at about 30° to 40°.

According to the calculation result, not only planarity of benzene rings of biphenyl but also planarity of the imide bond is vanished, hence, it can be understood that the structure is headed to have a structure in the direction of shortening a n conjugation in the molecular chain.

Since the polyimide of the present invention has such a spatial arrangement of a molecular structure, maintaining heat resistance of aromatic polyimide, the charge transfer on the molecular chain of polyimide is inhibited so as to form a transparent polyimide.

Also, the polyimide of the present invention exhibits a good dimensional stability which is a characteristic of aromatic polyimide. Further, since 2,2′,6′,6′-biphenyltetracarboxylic dianhydride, which is a starting material, can be obtained by a relatively simple synthesis method such as an oxidation reaction of pyrene or the like, it is available at a low price.

Polyimide which is produced using 2,2′,6,6′-biphenyltetracarboxylic dianhydride has been conventionally known, however, the physical property thereof has not been known in detail. Particularly, a property of good transparency has not ever known at all.

It is found by the present invention that polyimide which is produced using 2,2′,6,6′-biphenyltetracarboxylic dianhydride based on a novel molecular design to enhance transparency of polyimide has a good transparency due to a mechanism in which a conventional highly transparent polyimide does not have. The present invention shows suitable applications of polyimide in the field which can utilize its high transparency as well as original properties of polyimide such as heat resistance or the like.

In the repeating unit represented by the formula (1), a substituent other than a hydrogen atom may be introduced at the position of R¹ to R⁶. If the repeating unit represented by the formula (1) of the polyimide of the present invention has a seven-membered ring imide structure derived from 2,2′,6,6′-biphenyltetracarboxylic dianhydride, a transparency improves. Thus, even the substituent is introduced to R¹ to R⁶, a similar effect can be expected.

As a monovalent organic group which can be introduced to R¹ to R⁶ other than a hydrogen atom, there may be, for example, a halogen atom, a hydroxyl group, a mercapto group, a primary amino group, a secondary amino group, a tertiary amino group, a cyano group, a silyl group, a silanol group, an alkoxy group, a nitro group, a carboxyl group, an acetyl group, an acetoxy group, a sulfo group, a saturated or unsaturated alkyl group, a saturated or unsaturated halogenated alkyl group, an aromatic group such as phenyl, naphthyl or the like, an allyl group or the like. R¹ to R⁶may be the same or different from each other. Two or more groups among R¹ to R⁶, particularly, two or three groups among R¹ to R³ and/or two or three groups among R⁴ to R⁶ may be bonded each other to form a ring structure.

The substituents R¹ to R⁶ may be introduced in a state of a starting material so that a state of acid dianhydride has the substituents already introduced, or may be reacted with diamine so as to introduce it in a state of polyimide or polyamic acid. Also, a wavelength of light to be absorbed can be adjusted by introducing a substituent, hence, polyimide can be made to absorb a desired wavelength by introducing a substituent.

As a guide to determine kinds of substituent to be introduced in order to shift an absorption wavelength with respect to a desired wavelength, A. I. Scott, 1964, Interpretation of the Ultraviolet Spectra of Natural Products or a table in R. M. Silverstein, 1993, Identification of Organic Compound by Spectrum 5 may be of reference.

R⁷ in the formula (1) is a divalent organic group. There may be, for example, a divalent organic group which corresponds to each diamine component to be hereinafter described, that is, a structure comprising a diamine component without amino groups of both ends which are concerned in formation of a polyimide chain. Between each repeating unit which is present in the same polyimide chain, groups represented by the same symbol may be different atoms or structures.

In the polyimide of the present invention, at least a portion derived from acid dianhydride is aromatic polyimide having an aromatic imide structure. From the viewpoint of enhancing heat resistance and dimensional stability of polyimide, it is further preferable that a portion derived from diamine is also wholly aromatic polyimide including an aromatic structure. Therefore, it is preferable that R⁷, which is a structure derived from a diamine component, is a structure derived from aromatic diamine. Herein, the wholly aromatic polyimide means polyimide obtainable from copolymerization of an aromatic acid component and an aromatic amine component or polymerization of aromatic acid/amine component. Also, the aromatic acid component means a compound having all four acidic groups forming a polyimide frame (polyimide skeleton) are substituted on aromatic rings. The aromatic amine component means a compound having both of two amino groups forming a polyimide frame are substituted on aromatic rings. The aromatic acid/amine component means a compound having both acidic group and amino groups forming a polyimide frame substituted on aromatic rings. As it is clear from examples of a starting material to be hereinafter described, not all acidic groups or amino groups are necessary to be present on the same aromatic ring.

The solubility of the polyimide of the present invention may also be improved by introducing a substituent in the molecular structure. In this view, it is preferable that R¹ to R⁶ of the above-mentioned substituent is selected from the group consisting of a saturated and unsaturated alkyl group having 1 to 15 carbons, a saturated and unsaturated alkoxy group having 1 to 15 carbons, a bromo group, a chloro group, a fluoro group, a nitro group, a primary to tertiary amino group and the like. Also, these groups may be present at the divalent organic group “R⁷”.

Polyimide of the present invention may contain a repeating unit other than the formula (1) as far as the object of the present invention, which is to improve properties such as transparency, heat resistance, dimensional stability or the like, can be attained. For example, the polyimide of the present invention may contain a repeating unit having an imide structure other than the formula (1), or a repeating unit which is not an imide structure such as a repeating unit of an amide structure (a repeating unit of polyamide).

A repeating unit having an imide structure other than the formula (1) may be represented by the following formula (2). Polyimide containing a repeating unit represented by the formula (1) and a repeating unit represented by the formula (2) may be represented by the following formula (3). The polyimide represented by the formula (3) may contain a repeating unit other than the formula (1) and the formula (2): 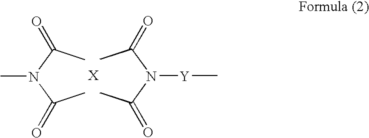
wherein, in the formula (2), “X” is a tetravalent organic group; and “Y” is a divalent organic group; 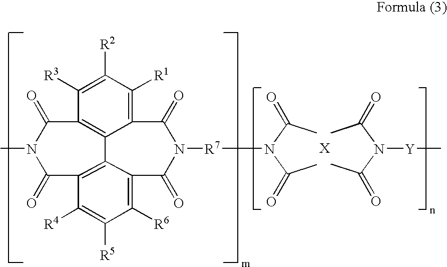
wherein, in the formula (2) and the formula (3), R¹ to R⁶, R⁷, “X” and “Y” are the same as in the formula (1) or the formula (2); among repeating units present in the same molecule, groups represented by the same symbol may be different atoms or structures; “m” is a natural number of 1 or more; “n” is a natural number of 0 or more; and the unit of the formula (1) and the unit of the formula (2) may be a random arrangement or an arrangement with regularity.

The imide structure other than the formula (1) may be introduced into a polyimide chain by using acid dianhydride other than 2,2′,6,6′-biphenyltetracarboxylic dianhydride or a derivative thereof.

As a production method of the polyimide of the present invention, conventional methods can be applied, for example:
(1) a method wherein acid dianhydride and diamine are synthesized to obtain polyamic acid, which is a precursor, forming is performed in this state of polyamic acid, and then imidization is performed by heating;
(2) a method wherein after obtaining polyimide liquid by heating amide acid in a liquid or using a dehydration catalyst such as acetic anhydride, dicyclohexylcarbodiimide or the like, forming is performed by means such as coating the polyimide liquid or the like; and
(3) a method wherein diimide monomer is synthesized using acid dianhydride and monoamine having two equivalency of reaction site, and then, diimide monomers are bonded to obtain polyimide.

Transparency of the polyimide of the present invention improves by forming a cyclic structure to be an intramolecular imide ring due to the mechanism exhibiting transparency. That is, the higher the intramolecular imide cyclization rate is at a synthesizing stage, the higher the transparency is. To the contrary, when a crosslinking reaction is performed at a portion which closes to form an imide ring of a precursor molecule so as to form multiple bonds with other precursor molecules, the intramolecular imide cyclization rate declines, which may cause coloring.

Hence, to pursue the transparency, the method (2) or (3) is preferable. When pursuing the transparency particularly severely, it is preferable to synthesize by the method (3) which surely enables the intramolecular imide cyclization rate to be 100%.

From the viewpoint of obtaining excellent transparency, it is preferable that an intramolecular imide cyclization rate is 80% by mole or more, more preferably 90% by mole or more. Herein, the intramolecular imide cyclization rate means a rate concerning an actual number of intramolecular imide cyclized portions with respect to a theoretical figure provided that 100% of portions capable of an intramolecular imide cyclization contained in a polyimide precursor are intramolecular imide ring cyclized. In order to determine an intramolecular imide cyclization rate of specific polyimide, an infrared spectrum, ¹H-NMR or ¹³C-NMR of liquid or solid or the like may be used.

Loss of the intramolecular imide cyclization reaction generates as a reactive portion capable of an imide cyclization reaction is consumed by a crosslinking reaction or left unreacted. Particularly, an influence of the consumption in a crosslinking reaction has a profound effect. Hence, in the present invention, the intramolecular imide cyclization may be evaluated whether it is sufficient by measuring an amount of crosslinking bond contained in the obtained polyimide. For example, when a rubbery region is not observed in a dynamic viscoelasticity measurement of polyimide, it can be assessed that an intramolecular imide cyclization rate is high. On the other hand, when a rubbery region is observed in the dynamic viscoelasticity measurement of polyimide, a crosslinked product is formed, thus, an intramolecular imide cyclization rate can be accessed as being lower than the case which the rubbery region is not observed. In fact, when the rubbery region is observed, a transparency of polyimide slightly lowers.

As aforementioned, as acid dianhydride used herein, not only 2,2′,6,6′-biphenyltetracarboxylic dianhydride but also a derivative preliminary having a substituent introduced at one or more of R¹ to R⁶ according to the purpose. As the acid dianhydride, acid dianhydride other than 2,2′,6,6′-biphenyltetracarboxylic dianhydride and/or the derivative thereof may be used together. Two or more of 2,2′,6,6′-biphenyltetracarboxylic dianhydride and/or the derivative thereof and other acid dianhydrides may be used together as far as polyimide has transparency.

As the acid dianhydride which can be used together with 2,2′,6,6′-biphenyltetracarboxylic dianhydride and/or the derivative thereof, aromatic acid dianhydride is preferable from the viewpoint of a heat resistance. According to desired physical properties, acid dianhydride other than 2,2′,6,6′-biphenyltetracarboxylic dianhydride may be used within 50% by mole, preferably 30% by mole, of the whole amount of acid dianhydride.

As another acid dianhydride which can be used together with 2,2′,6,6′-biphenyltetracarboxylic dianhydride and/or the derivatives at the same time, there may be, for example, ethylenetetracarboxylic dianhydride, butanetetracarboxylic dianhydride, cyclobutanetetracarboxylic dianhydride, cyclopentanetetracarboxylic dianhydride, pyromellitic dianhydride, 3,3′,4,4′-benzophenonetetracarboxylic dianhydride, 2,2′,3,3′-benzophenonetetracarboxylic dianhydride, 3,3′,4,4′-biphenyltetracarboxylic dianhydride, 2,2′,3,3′-biphenyltetracarboxylic dianhydride, 2,2-bis(3,4-dicarboxyphenyl)propane dianhydride, 2,2-bis(2,3-dicarboxyphenyl)propane dianhydride, bis(3,4-dicarboxyphenyl)ether dianhydride, bis(3,4-dicarboxyphenyl)sulfone dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 2,2-bis(3,4-dicarboxyphenyl)-1,1,1,3,3,3-hexafluoropropane dianhydride, 2,2-bis(2,3-dicarboxyphenyl)-1,1,1,3,3,3-hexafluoropropane dianhydride, 1,3-bis[(3,4-dicarboxy)benzoyl]benzene dianhydride, 1,4-bis[(3,4-dicarboxy)benzoyl]benzene dianhydride, 2,2-bis{4-[4-(1,2-dicarboxy)phenoxy]phenyl}propane dianhydride, 2,2-bis{4-[3-(1,2-dicarboxy)phenoxy]phenyl}propanedianhydride, bis{4-[4-(1,2-dicarboxy)phenoxy]phenyl}ketonedianhydride, bis{4-[3-(1,2-dicarboxy)phenoxy]phenyl}ketone dianhydride, 4,4′-bis[4-(1,2-dicarboxy)phenoxy]biphenyl dianhydride, 4,4′-bis[3-(1,2-dicarboxy)phenoxy]biphenyl dianhydride, bis{4-[4-(1,2-dicarboxy)phenoxy]phenyl}ketone dianhydride, bis{4-(3-(1,2-dicarboxy)phenoxy]phenyl}ketone dianhydride, bis{4-[4-(1,2-dicarboxy)phenoxy]phenyl}sulfonedianhydride, bis{4-[3-(1,2-dicarboxy)phenoxy]phenyl}sulfonedianhydride, bis{4-[4-(1,2-dicarboxy)phenoxy]phenyl}sulfidodianhydride, bis{4-[3-(1,2-dicarboxy)phenoxy]phenyl}sulfidodianhydride, 2,2-bis{4-[4-(1,2-dicarboxy)phenoxy phenyl}-1,1,1,3,3,3-hexafulpropane dianhydride, 2,2-bis{4-[3-(1,2-dicarboxy)phenoxy]phenyl}-1,1,1,3,3,3-propane dianhydride, 2,3,6,7-naphthalenetetracarboxylic dianhydride, 1,4,5,8-naphthalenetetracarboxylic dianhydride, 1,2,5,6-naphthalenetetracarboxylic dianhydride, 1,2,3,4-benzenetetracarboxylic dianhydride, 3,4,9,10-perylenetetracarboxylic dianhydride, 2,3,6,7-anthracenetetracarboxylic dianhydride, 1,2,7,8-phenanthrenetetracarboxylic dianhydride or the like. They may be used solely or in a mixture of two or more kids. As tetracarboxylic dianhydride which may be used more preferably, there may be pyromellitic dianhydride, 3,3′,4,4′-benzophenonetetracarboxylic dianhydride, 3,3′,4,4′-biphenyltetracarboxylic dianhydride, bis(3,4-dicarboxyphenyl)ether dianhydride, or 2,2-bis(3,4-dicarboxyphenyl)-1,1,1,3,3,3-hexafluoropropane dianhydride.

IF acid dianhydride having fluorine introduced or acid dianhydride having an alicyclic structure is used as acid dianhydride for using together, physical properties such as solubility, thermal expansion coefficient or the like can be adjusted without appreciable decline in transparency. Also, if rigid acid dianhydride such as pyromellitic anhydride, 3,3′,4,4′-biphenyltetracarboxylic dianhydride, 1,4,5,8-naphthalene tetracarboxylic dianhydride or the like is used, the coefficient of linear thermal expansion decreases. However, the rigid acid dianhydride tends to inhibit improvement of transparency, thus may be used together caring about copolymerization ratio.

On the other hand, one kind of diamine may be solely used or two or more kinds of diamine may be used together for an amine component. As useable diamines, there may be, but may not be limited thereto, p-phenylenediamine, m-phenylenediamine, o-phenylenediamine, 3,3′-diaminodiphenyl ether, 3,4′-diaminodiphenyl ether, 4,4′-diaminodiphenyl ether, 3,3′-diaminodiphenyl sulfido, 3,4′-diaminodiphenyl sulfido, 4,4′-diaminodiphenyl sulfido, 3,3′-diaminodiphenyl sulfone, 3,4′-diaminodiphenyl sulfone, 4,4′-diaminodiphenyl sulfone, 3,3′-diaminobenzophenone, 4,4′-diaminobenzophenone, 3,4′-diaminobenzophenone, 3,3′-diaminodiphenylmethane, 4,4′-diaminodiphenylmethane, 3,4′-diaminodiphenylmethane, 2,2-di(3-aminophenyl)propane, 2,2-di(4-aminophenyl)propane, 2-(3-aminophenyl)-2-(4-aminophenyl)propane, 2,2-di(3-aminophenyl)-1,1,1,3,3,3-hexafluoropropane, 2,2-di(4-aminophenyl)-1,1,1,3,3,3-hexafluoropropane, 2-(3-aminophenyl)-2-(4-aminophenyl)-1,1,1,3,3,3-hexafluoropropane, 1,1-di(3-aminophenyl)-1-phenylethane, 1,1-di(4-aminophenyl)-1-phenylethane, 1-(3-aminophenyl)-1-(4-aminophenyl)-1-phenylethane, 1,3-bis(3-aminophenoxy)benzene, 1,3-bis(4-aminophenoxy)benzene, 1,4-bis(3-aminophenoxy)benzene, 1,4-bis(4-aminophenoxy)benzene, 1,3-bis(3-aminobenzoyl)benzene, 1,3-bis(4-aminobenzoyl)benzene, 1,4-bis(3-aminobenzoyl)benzene, 1,4-bis(4-aminobenzoyl)benzene, 1,3-bis(3-amino-α,α-dimethylbenzyl)benzene, 1,3-bis(4-amino-α,α-dimethylbenzyl)benzene, 1,4-bis(3-amino-α,α-dimethylbenzyl)benzene, 1,4-bis(4-amino-α,α-dimethylbenzyl)benzene, 1,3-bis(3-amino-α,α-ditrifluoromethylbenzyl)benzene, 1,3-bis(4-amino-α,α-ditrifluoromethylbenzyl)benzene, 1,4-bis(3-amino-α,α-ditrifluoromethylbenzyl)benzene, 1,4-bis(4-amino-α,α-ditrifluoromethylbenzyl)benzene, 2,6-bis(3-aminophenoxy)benzonitrile, 2,6-bis(3-aminophenoxy)pyridine, 4,4′-bis(3-aminophenoxy)biphenyl, 4,4′-bis(4-aminophenoxy)biphenyl, bis[4-(3-aminophenoxy)phenyl]ketone, bis[4-(4-aminophenoxy)phenyl]ketone, bis[4-(3-aminophenoxy)phenyl]sulfido, bis[4-(4-aminophenoxy)phenyl]sulfido, bis[4-(3-aminophenoxy)phenyl]sulfone, bis[4-(4-aminophenoxy)phenyl]sulfone, bis[4-(3-aminophenoxy)phenyl]ether, bis[4-(4-aminophenoxy)phenyl]ether, 2,2-bis[4-(3-aminophenoxy)phenyl]propane, 2,2-bis[4-(4-aminophenoxy)phenyl]propane, 2,2-bis[3-(3-aminophenoxy)phenyl]-1,1,1,3,3,3-hexafluoropropane, 2,,2-bis[4-(4-aminophenoxy)phenyl]-1,1,1,3,3,3-hexafluoropropane, 1,3-bis[4-(3-aminophenoxy)benzoyl]benzene, 1,3-bis[4-(4-aminophenoxy)benzoyl]benzene, 1,4-bis[4-(3-aminophenoxy)benzoyl]benzene, 1,4-bis[4-(4-aminophenoxy)benzoyl]benzene, 1,3-bis[4-(3-aminophenoxy)-α,α-dimethylbenzyl]benzene, 1,3-bis[4-(4-aminophenoxy)-α,α-dimethylbenzyl]benzene, 1,4-bis[4-(3-aminophenoxy)-α,α-dimethylbenzyl]benzene, 1,4-bis[4-(4-aminophenoxy)-α,α-dimethylbenzyl]benzene, 4,4′-bis[4-(4-aminophenoxy)benzoyl]diphenylether, 4,4′-bis[4-(4-amino-α,α-dimethylbenzyl)phenoxy]benzophenone, 4,4′-bis[4-(4-amino-α,α-dimethylbenzyl)phenoxy]diphenylsulfone, 4,4′-bis[4-(4-aminophenoxy)phenoxy]diphenylsulfone, 3,3′-diamino-4,4′-diphenoxybenzophenone, 3,3′-diamino-4,4′-dibiphenoxybenzophenone, 3,3′-diamino-4-phenoxybenzophenone, 3,3′-diamino-4-biphenoxybenzophenone, 6,6′-bis(3-aminophenoxy)-3,3,3′,3′-tetramethyl-1,1′-spirobiindane, 6,6′-bis(4-aminophenoxy)-3,3,3′,3′-tetramethyl-1,1′-spirobiindane, 1,3-bis(3-aminopropyl)tetramethyldisiloxane, 1,3-bis(4-aminobutyl)tetramethyldisiloxane, α,ω-bis(3-aminopropyl)polydimethylsiloxane, α,ω-bis(3-aminobutyl)polydimethylsiloxane, bis(aminomethyl)ether, bis(2-aminoethyl)ether, bis(3-aminopropyl)ether, bis(2-aminomethoxy)ethyl]ether, bis[2-(2-aminoethoxy)ethyl]ether, bis[2-(3-aminoprotoxy)ethyl]ether, 1,2-bis(aminomethoxy)ethane, 1,2-bis(2-aminoethoxy)ethane, 1,2-bis[2-(aminomethoxy)ethoxy]ethane, 1,2-bis[2-(2-aminoethoxy)ethoxy]ethane, ethylene glycol bis(3-aminopropyl)ether, diethylene glycol bis(3-aminopropyl)ether, triethylene glycol bis(3-aminopropyl)ether, ethylenediamine, 1,3-diaminopropane, 1,4-diaminobutane, 1,5-diaminopentane, 1,6-diaminohexane, 1,7-diaminoheptane, 1,8-diaminooctane, 1,9-diaminononane, 1,10-diaminodecane, 1,11-diamino undecane, 1,12-diaminododecane, 1,2-diaminocyclohexane, 1,3-diaminocyclohexane, 1,4-diaminocyclohexane, 1,2-di(2-aminoethyl)cyclohexane, 1,3-di(2-aminoethyl)cyclohexane, 1,4-di(2-aminoethyl)cyclohexane, bis(4-aminocyclohexyl)methane, 2,6-bis(aminomethyl)bicyclo[2,2,1]heptane, or 2,5-bis (aminomethyl)bicyclo[2,2, 1]heptane. Also, diamine in which a part or all of the hydrogen atoms on the aromatic ring of the above-mentioned diamine is substituted by a substituent selected from the group consisting of a fluoro group, a methyl group, a methoxy group, a trifluoromethyl group, or a trifluoromethoxy group can also be used. Moreover, according to the purpose, diamine in which a part or all of the hydrogen atoms on the aromatic ring has one or more groups among an ethinyl group, a benzocyclobutene-4′-yl group, a vinyl group, an allyl group, a cyano group, an isocyanate group, and an isopropenyl group to be crosslinked points introduced as a substituent on the aromatic ring can also be used.

Diamine can be selected according to the desired physical property. When rigid diamine such as p-phenylenediamine or the like is used, the coefficient of expansion becomes low. As rigid diamine which two amino groups bonds together to the same aromatic ring, there may be p-phenylenediamine, m-phenylenediamine, 1,4-diaminonaphthalene, 1,5-diaminonaphthalene, 2,6-diaminonaphthalene, 2,7-diaminonaphthalene, 1,4-diaminoanthracene or the like.

Further, there maybe diamine in which two or more aromatic rings are bonded by single bonds and two or more amino groups are respectively bonded on a different aromatic ring directly or as apart of a substituent. For example, the following formula (4) may be exemplified. Specifically, there may be benzidine or the like: 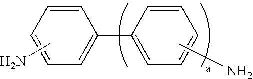
wherein, “a” is a natural number of 1 or more; and the amino groups bond in a para or meta position relative to the bond between the benzene rings.

Further, in the formula (4), diamine having substituents which are not concerned in bonding with other benzenes at positions of the benzene rings where no amino group is substituted may be used. The substituents are monovalent organic groups, which may be bonded each other.

Specifically, for example , there may be 2,2′-dimethyl-4,4′-diaminobiphenyl, 2,2′-ditrifluoromethyl-4,4′-diaminobiphenyl, 3,3′-dichloro-4,4′-diaminobiphenyl, 3,3′-dimethoxy-4,4′-diaminobiphenyl, 3,3′-dimethyl-4,4′-diaminobiphenyl or the like.

For a use as an optical waveguide or an optical circuit part, a transmittance with respect to an electromagnetic wave having a wavelength of 1 μm or more can be improved if fluorine is introduced as a substituent of the aromatic ring.

On the other hand, if diamine having a siloxane structure such as 1,3-bis(3-aminopropyl)tetramethyl disiloxane or the like as diamine, an elastic modulus decreases and the glass transition temperature can be lowered.

Herein, aromatic diamine is preferably selected as the diamine from the viewpoint of heat resistance. Diamine other than aromatic series such as a liphatic diamine, siloxane based diamine or the like may be also used according to the desired physical properties within 60% by mole, preferably 40% by mole, of the whole amount of diamine.

Next, a synthesizing method of 2,2′,6,6′-biphenyltetracarboxylic dianhydride which is a starting material of the polyimide of the present invention and a synthesis method of the polyimide will be described in more detail hereinafter, however, the present invention is not limited thereto.

2,2′,6,6′-biphenyltetracarboxylic dianhydride, which has the most basic structure among acid component materials, can be obtained by an oxidation reaction of pyrene. That is, firstly, pyrene is solved in dichloromethane. After solving the pyrene completely, acetonitrile and water are added and agitated. Sodium periodate as an oxidizer and ruthenium trichloride as a catalyst are added thereto followed by agitation for 10 to 30 hours at room temperature. After reaction, a precipitate is filtered. The precipitate is extracted with acetone followed by filtering. The acetone used for extraction is concentrated followed by drying, and refluxed by dichloromethane for 4 to 10 hours followed by filtering. The obtained white solid is 2,2′,6,6′-biphenyltetracarboxylic acid, which is a precursor of 2,2′,6,6′-biphenyltetracarboxylic dianhydride. After the obtained 2,2′,6,6′-biphenyltetracarboxylic acid is refluxed with acetic anhydride for 3 hours, a solvent is distilled away. The obtained solid matter is refined by sublimation under the condition of 0.8 mmHg (106.4 Pa) pressure and 230° C., thus obtained a desired 2,2′,6,6′-biphenyltetracarboxylic dianhydride.

Next, an example of synthesis of polyimide using the above-mentioned 2,2′,6,6′-biphenyltetracarboxylic dianhydride as an acid component and 4,4′-diamino diphenyl ether as an amine component will be explained. First, equimolar 2,2′,6,6′-biphenyltetracarboxylic dianhydride is gradually added to dimethylacetamide having 4,4′-diamino diphenyl ether solved followed by agitation at room temperature. After about 1 to 20 hours of agitation, a reaction solution is dropped to agitated diethyl ether to reprecipitate, thereby, polyamic acid is obtained. The polyamic acid is again solved to dimethylacetamide and applied on a substrate such as a glass or the like to dry, thereby, a coating layer of polyamic acid is formed. Then, after heating, a coating layer of polyimide is obtained.

Also, in the case of performing a chemical imidization instead of the heating and dehydration, a conventional compound such as amine such as pyridine, β-picolinic acid or the like, carbodiimide such as dicyclohexylcarbodiimide or the like, acid anhydride such as acetic anhydride or the like may be used as a dehydration catalyst. As the acid anhydride, there may be not only the acetic anhydride but also propionic anhydride, n-butyric anhydride, benzoic anhydride, trifluoroacetic anhydride or the like, but may not be particularly limited. Also, tertiary amine such as pyridine, β-picolinic acid or the like may be used together.

In order to make original properties of polyimide such as heat resistance and dimensional stability excellent, the polyimide of the present invention as synthesized above, it is preferable that a copolymerization ratio of an aromatic acid component and/or an aromatic amine component is large as much as possible. Specifically, it is preferable that a ratio of the aromatic acid component with respect to an acid component constituting a repeating unit of an imide structure is 50% by mole or more, particularly 70% by mole or more. It is preferable that a ratio of the aromatic amine component with respect to an amine component constituting the repeating unit of the imide structure is 40% by mole or more, particularly 60% by mole or more. Wholly aromatic polyimide is particularly preferable.

From the viewpoint of attaining transparency, it is preferable that in the polyimide of the present invention, 50% by mole or more, particularly 70% by mole or more, of the repeating unit of the imide structure present in the polyimide chain is the repeating unit represented by the formula (1). Also, from the viewpoint of heat resistance and dimensional stability, it is preferable that the repeating unit represented by the formula (1) is a repeating unit of the wholly aromatic polyimide.

The polyimide of the present invention synthesized as above is characterized in high transparency. It is preferable that a light transmittance of each wavelength of wavelength area between 400 nm to 800 nm when formed into a film having a thickness of 1 μm, preferably 2 μm, is 85% or more. Also, it is further preferable that a total light transmittance (JIS K7105) is 90% or more.

It is preferable that a weight average molecular weight of the polyimide of the present invention is, though depending on its use, between 3,000 and 1,000,000, more preferably between 5,000 and 500,000, most preferably between 10,000 and 500,000. If the weight average molecular weight is 3,000 or less, a sufficient strength is hard to obtain when it is made into a coating layer or a film. Also, if the weight average molecular weight is less than 10,000, number of terminals of a polymer, which is a cause of coloring, relatively increases, thereby coloring may be caused. On the other hand, if the weight average molecular weight is more than 1,000,000, a viscosity increases and a solubility declines, hence, it is hard to obtain a coating layer or a film having a smooth surface and a uniform thickness.

The polyimide of the present invention also keeps original properties of polyimide such as heat resistance, dimensional stability, insulation and the like, which are excellent.

For example, a 5% reduction in weight temperature measured in nitrogen atmosphere is preferably 250° C. or more, more preferably 300° C. or more. Particularly, in the case that its use is an electronic part or the like, the production method of which includes a solder reflow process, if the 5% reduction in weight temperature is 300° C. or less, there is a risk that a defect such as a bubble or the like may occur due to a cracked gas generated in the solder reflow process. Herein, the 5% reduction in weight temperature means a temperature at which a weight of a sample is reduced by 5% of an initial weight (that is to say, a temperature at which the weight of the sample is reduced to 95% of the initial weight) when a decrement of weight is measured using the thermogravimetric analyzer. Similarly, a 10% reduction in weight temperature means a temperature at which a weight of a sample is reduced by 10% of an initial weight.

Higher glass transition temperature is better from the viewpoint of heat resistance, however, if a use may include a thermoforming process such as an optical waveguide, a glass transition temperature is preferably about 120° C. to 380° C., more preferably about 200° C. to 380° C.

From the viewpoint of dimensional stability, the coefficient of linear thermal expansion is preferably 60 ppm or less, more preferably 40 ppm or less. In the case of using a film substrate for a flexible display or the like as a replacement of glass, a glass transition temperature of 20 ppm or less is more preferable.

As aforementioned, the polyimide of the present invention exhibits good transparency without introducing fluorine or an alicyclic structure. Hence, conventionally unavoidable problems due to the introduction of fluorine or an alicyclic structure such as lowering of original physical properties of polyimide such as heat resistance, dimensional stability or the like, and rise of cost can be solved. Also, a coating layer, film or molded article of polyimide having heat resistance equal to conventional aromatic polyimide and high transparency can be obtained.

The polyimide of the present invention may be subject to a coating or molding process for producing a product or member as it is, or may be solved or dispersed in a solvent if required. Further, a polyimide resin composition may be prepared by compounding a photo- or heat-curable component, a non-polymerizable binder resin other than the polyimide of the present invention and other components.

As a solvent to solve, disperse or dilute the polyimide resin composition, various general solvents may be used.

As a usable general solvent, for example, there may be ethers such as diethyl ether, tetrahydrofuran, dioxane, ethylene glycol dimethyl ether, ethylene glycol diethyl ether, propylene glycol dimethyl ether, propylene glycol diethyl ether or the like; glycol monoethers (that is, cellosolves) such as ethylene glycol monomethyl ether, ethylene glycol monoethyl ether, propylene glycol monomethyl ether, propylene glycol monoethyl ether, diethylene glycol monomethyl ether, diethylene glycol monoethyl ether or the like; ketones such as methyl ethyl ketone, acetone, methyl isobutyl ketone, cyclopentanone, cyclohexanone or the like; esters such as ethyl acetate, butyl acetate, n-propyl acetate, i-propyl acetate, n-butyl acetate, i-butyl acetate, acetic ester (for example, methyl cellosolve acetate, ethyl cellosolve acetate) of the above-mentioned glycol monoethers, methoxypropyl acetate, ethoxypropyl acetate, dimethyl oxalate, methyl lactate, ethyl lactate or the like; alcohols such as ethanol, propanol, butanol, hexanol, cyclohexanol, ethylene glycol, diethylene glycol, glycerin or the like; halogenated hydrocarbons such as methylene chloride, 1,1-dichloroethane, 1,2-dichloroethylene, 1-chloropropane, 1-chlorobutane, 1-chloropentane, chlorobenzene, bromobenzene, o-dichlorobenzene, m-dichlorobenzene or the like; amides such as N,N-dimethylformamide, N,N-dimethylacetamide or the like; pyrrolidones such as N-methyl pyrrolidone or the like; lactones such as y-butyrolactone or the like; sulfoxides such as dimethyl sulfoxide or the like, the other organic polar solvents or the like. Moreover, there may be aromatic hydrocarbons such as benzene, toluene, xylene or the like and other organic nonpolar solvents or the like. These solvents can be used alone or in combination.

As a photocurable component, a compound having one or more ethylenically unsaturated bonds may be used. For example, there may be aromatic vinyl compounds such as an amide-based monomer, a (meth)acrylate monomer, a urethane (meth)acrylate oligomer, a polyester (meth)acrylate oligomer, epoxy (meth)acrylate, and (meth)acrylate including a hydroxyl group, styrene or the like. Herein, “(meth) acrylate” means either acrylate or methacrylate.

When using such a photocurable compound having an ethylenic unsaturated bond, a photoradical generator may be further added.

Also, as the photo- or heat-curable component other than the photocurable compound having an ethylenic unsaturated bond or the other non-polymerizable binder resin, a conventional polymer compound, a radical reactive compound or a curable reactive compound other than the radical reactive compound may be used. There may be, for example, organic polyisocyanate such as tolylene diisocyanate, 4,4′-diphenyl methane diisocyanate, 4,4′-dicyclohexyl methane diisocyanate, hexamethylene diisocyanate, isophorone diisocyanate or the like; a polymer and copolymer of an acrylic or vinyl compound such as vinyl acetate, vinyl chloride, acrylic ester, methacrylate or the like; a styrene resin such as polystyrene or the like; an acetal resin such as a formal resin, a butyral resin or the like; a silicone resin; a phenoxy resin; an epoxy resin represented by a bisphenol A type epoxy resin or the like; an urethane resin such as polyurethane or the like; a phenol resin; a ketone resin; a xylene resin; a polyamide resin and its precursor; a polyimide resin and its precursor; a polyether resin; a polyphenylene ether resin; a polybenzoxazole resin; a cyclic polyolefin resin; a polycarbonate resin; a polyester resin; a polyarylate resin; a polystyrene resin; a novolak resin; an alicyclic polymer such as polycarbodiimide, polybenzimidazole, polynorbornene or the like; any conventionally known high-molecular compound or curable reactive compound such as a siloxane polymer or the like, but may not be limited. They may be used alone or in combination.

In the case of using the binder resin of a non-polymerizable polymer, though depending on uses of the resin composition, generally, a weight average molecular weight is preferably 3,000 or more. Also, if a molecular weight is too high, a solubility or process property may be deteriorated, thus generally, the weight average molecular weight is preferably 10,000,000 or less.

In order to impart a process property or various functionalities to the resin composition of the present invention, various organic or inorganic low molecules or polymer compounds may be also compounded besides the above. For example, dyes, surfactants, leveling agents, plasticizers, microparticles, sensitization agents or the like may be used. The microparticles may include organic microparticles such as polystyrene, polytetrafluoroethylene or the like, inorganic microparticles such as colloidal silica, carbon, phyllosilicate or the like, which may be porous or have a hollow structure. Examples of the function or form of these microparticles include pigments, fillers, fibers or the like.

The polyimide resin composition of the present invention generally contains the polyimide represented by the formula (1) by 5% by weight to 99.9% by weight based on the total amount of solids of the resin composition. Also, a compounding ratio of other optional components is preferably in the range of 0.1% by weight to 95% by weight based on the total amount of solids of the resin composition. If the proportion is less than 0.1% by weight, it is difficult to exhibit the effect of the added additives whereas if the proportion exceeds 95% by weight, it is difficult to reflect the characteristics of the resin composition upon a final product. It is to be noted that the solid content of the polyimide resin composition means the whole components other than solvents and a liquid monomer component is included in the solid content.

The polyimide resin composition of the present invention may be used in all known fields and products such as pattern-forming materials (resists), coating materials, paints, printing inks, adhesives, fillers, electronic materials, molding materials, resist materials, building materials, three-dimensional articles, flexible display films, optical members or the like.

Particularly, as the polyimide resin composition of the present invention has high transparency besides original properties of polyimide such as heat resistance, dimensional stability, insulation or the like, it is suitable for products of fields which are effective of these properties such as forming paints, printing inks, color filters, flexible display films, electronic parts, layer insulation films, wire cover films, optical circuits, optical circuit parts, antireflection films, holograms, other optical members or building materials.

Also, as the polyimide resin composition has high transparency besides heat resistance, dimensional stability and insulation, the polyimide resin composition is suitable for films or coating layers for all known members requiring transparency, and expected to be utilized for, for example, films or structures for optical members having high heat resistance such as antireflection films, optical circuit parts, holograms or the like.

Further, the present invention may be wholly aromatic polyimide having a high transparency, thus, since analiphatic polymer having carbon-hydrogen bonds has an absorption around 1.55 μm, which is a wavelength range used by an optical signal, it is applicable to optical signal waveguides and optical circuit parts such as wave dividers or the like which are difficult to apply. Particularly, it is effective to the cases that a transmittance is high in the range of visible light such as 800 nm or the like and multiple wavelengths are simultaneously used at wavelength multiplexing.

Further, the polyimide resin composition is greatly expected to be used for a substrate of an optical member as a glass replacing material which is light-weighted and can be flexible, for example, a substrate for a thin display such as a liquid crystal display, organic EL or the like.

### EXAMPLES

### Productive Example 1

A 2 L eggplant-shape flask was charged with 15 g (74 mmol) of pyrene and the pyrene was dissolved by dichloromethane. After pyrene was completely dissolved, 320 ml of acetonitrile and 480 ml of distilled water were added and agitated. Thereto, 150 g of sodium periodate being an oxidant and 650 mg of ruthenium (III) chloride being a catalyst were added and agitated at ambient temperature for 22 hours. After reaction, a precipitate was filtrated, and the precipitate was extracted using acetone and filtrated. After the extracted acetone was condensed and dried, then refluxed using dichloromethane for four hours, followed by filtrating to obtain a powder. Until the powder was completely changed to a white color, the extraction using acetone and reflux using dichloromethane were repeated, thereby 10.2 g of 2,2′,6,6′-biphenyltetracarboxylic acid was obtained.

The obtained 2,2′,6,6′-biphenyltetracarboxylic acid was refluxed using acetic anhydride for three hours, then the solvent was removed. The obtained solid substance was refined by sublimation under the condition of a pressure of 0.8 mmHg (106.4 Pa) and a temperature of 230° C., thereby a desired white powder of 2,2′,6,6′-biphenyltetracarboxylic dianhydride (2,2′,6,6′-BPDA) was obtained.

### Productive Example 2

A 50 mL three-neck flask was charged with 0.82 g (6 mmol) of p-aminobenzoic acid and the p-aminobenzoic acid was dissolved by 10 ml of dimethylformamide (DMF). Thereto, 0.88 g (3 mmol) of 2,2′,6,6′-BPDA was added little by little and agitated at ambient temperature for 5 hours. Then, 10 ml of acetic anhydride was added and agitated at 120° C. for 5 hours. After reaction, the reaction solution was cooled to ambient temperature. Then, the reaction solution was dropped to 500 ml of saturated sodium hydrogen carbonate solution to re-precipitate. Thereby, a white powder of diimide compound 1 having carboxylic acid in the ends was obtained.

### Example 1

A 200 ml eggplant-shape flask was charged with 1.64 g (2 mmol) of the diimide compound 1 and 20 ml of toluene, and agitated. Thereto, 50 ml of thionyl chloride was added, and then agitated at 120° C. for 5 hours. After reaction, the solvent and thionyl chloride were removed by a rotary evaporator, thereby acid chloride was obtained. Thereto, 20 ml of dichloromethane which was preliminarily dehydrated was added and the acid chloride was dissolved, then the solution was dropped to a tetrahydrofuran solution in which 0.45 g (2 mmol) of 4,4′-isopropylidenediphenol and 0.30 g (3 mmol) of triethylamine were dissolved and dehydrated followed by agitation at 50° C. for 4 hours. After the solution containing a precipitate was re-precipitated using distilled water, the solution was dissolved in DMF. Then, the solution was re-precipitated using hexane, thereby a desired polyimide was obtained as a white powder (polyimide 1).

### Example 2

(1) Synthesis of a Precursor Solution 1

A 50 ml three-neck flask was charged with 1.20 g (6mmol) of 4,4′-diaminodiphenyl ether and the 4,4′-diaminodiphenyl ether was dissolved by 5 ml of N-methyl-2-pyrrolidone dehydrated (NMP), then agitated under nitrogen flow while cooling the flask in an ice bath. Thereto, 1.77 g (6 mmol) of 2,2′,6,6′-BPDA divided into 10 equal parts was added little by little every 30 minutes. After addition, the solution was agitated in an ice bath for 5 hours. Thereby, a viscous liquid (a precursor solution 1) having a transparency was obtained.

(2) Synthesis of Polyimide 2

A 50 ml eggplant-shape flask was charged with 1 g of the precursor solution 1 and 4 ml of NMP dehydrated and agitated. Thereto, 2 ml of acetic anhydride was added and agitated at 100° C. for 24 hours. The solution was re-precipitated using diethyl ether, thereby 370 mg of a white powder was obtained (polyimide 2). The weight average molecular weight with polystyrene standard using GPC (gel-permeation chromatography) was 64,000.

### Example 3

A 50 ml eggplant-shape flask was charged with 1 g of a precursor solution 1 synthesized in Example 2 and 4 ml of NMP dehydrated, and agitated. Thereto, 2ml of trifluoroacetic anhydride was added and agitated at 100° C. for 24 hours. The solution was re-precipitated using diethyl ether, thereby 370 mg of a white powder (polyimide 3) was obtained. The weight average molecular weight with polystyrene standard using GPC was 13,000.

### Example 4

The precursor solution 1 synthesized in Example 2 was spin coated directly on a glass substrate, then dried on a hot plate heated to 140° C. for 30 minutes. Then, by heating at 300° C. for 1 hour in an oven under the air, thereby polyimide (polyimide 3) insoluble to NMP was obtained.

### Example 5

(1) Synthesis of a Precursor Solution 2

A 50 ml three-neck flask was charged with 1.20 g (6 mmol) of 4,4′-diaminodiphenyl ether, the 4,4′-diaminodiphenyl ether was dissolved by 5 ml of N-methyl-2-pyrrolidone (NMP), and agitated under nitrogen flow at ambient temperature. Thereto, 1.77 g (6 mmol) of 2,2′,6,6′-BPDA was added at a time. By addition, a large heat generation was observed. After addition, the solution was agitated for 5 hours, thereby a light brown liquid (a precursor solution 2) was obtained.

(2) Synthesis of Polyimide 5

A 50 ml eggplant-shape flask was charged with 1 g of the precursor solution 2 and 4 ml of NMP and agitated. Thereto, 2 ml of acetic anhydride was added and agitated at 100° C. for 24 hours. The solution was re-precipitated using diethylether, thereby 350 mg of a pale brown powder (polyimide 5) was obtained. The weight average molecular weight with polystyrene standard using GPC was 6,800.

[Evaluation of Transparency]

A coating layer having a thickness of about 2 μm was formed on a glass substrate using a 15% by weight DMF solution of the polyimide by a spin coating. A transmittance between 400 and 800 nm of the coating layer was measured by a spectrometer (UV-2550 (PC) S GLP; manufactured by Shimadzu Corporation). Thereby, the transmittance was 90% or more in all wavelengths.

[Evaluation of Transparency 2]

The polyimide 2, 4 and 5 and the precursor solution 1 were formed by a spin coating to a glass substrate. A transmittance between 400 and 800 nm of each coating layer was measured by a spectrometer (UV-2550 (PC) S GLP; manufactured by Shimadzu Corporation). As for the polyimide2 and 5, a polymer powder thereof was dissolved in NMP respectively, and spin coated followed by drying on a hot plate heated to 140° C. for 30 minutes. The precursor solution 1 was spin coated as it is followed by drying on a hot plate heated to 140° C. for 30 minutes. The polyimide 4 produced in Example 4 was used as it is.

The measured results are shown as a graph in FIG. 2. The transmittance at a wavelength of about 470 nm or less of the polyimide 5 having a low molecular weight in a layer having a thickness of about 1 μm was 85%. On the other hand, each of polyimide 2 and 4 having a high molecular weight derived from the precursor solution 1 was good intransmittance despite having a layer thickness of 1 μm or more exhibiting transmittance of 85% or more in the range of 400 to 800 nm including the precursor thereof. It can be considered that when a precursor has low molecular weight, the number of polymer ends is large, thereby coloring due to polymer ends is caused leading to decrease in transmittance.

In the case that polyimide is not formed by a method wherein diimide compounds are linked to form polyimide such as in Example 1, but by a method wherein polyimide is formed using polyamic acid being a precursor such as in Examples 2 to 5, by a dehydration and ring-closure reaction caused by a chemical reaction using a catalyst or by heating, in a dehydration and ring closure reaction in a molecule of a chemical imidization product represented by the polyimide 2 (an imidization product by a chemical dehydration and ring-closure reaction) tends to progress easily. However, in the case of a heat imidization product (an imidization product by a dehydration and ring-closure reaction with heating), a cross-linking reaction between molecules partially occurs besides a dehydration and ring-closure reaction. The intermolecular cross-linking may be the cause of coloring because the transparency of polyimide is exhibited by having a seven-membered ring imide structure to shorten a conjugation of a π electron in the case of polyimide of the present invention. Accordingly, it can be considered that the transmittance of the polyimide 4 is slightly lower than that of the polyimide 2.

[Evaluation of Thermophysical Properties]

An NMP solution of the polyimide 2 was applied on a film of UPILEX S 50S (product name; manufactured by Ube Industries, Ltd.) attached to a glass substrate. Then, the glass substrate was dried on a hot plate heated to 140° C. for 30 minutes followed by peeling, thereby a film having a thickness of 5 μm was obtained.

Similarly, after the precursor solution 1 was coated on a film of UPILEX S 50S (product name; manufactured by Ube Industries, Ltd.) attached to a glass substrate followed by drying on a hot plate heated to 140° C. for 30 minutes and peeling, the peeled film was heated at 300° C. for 1 hour in an oven under the air. Thereby, a polyimide film having a thickness of 45 μm was obtained. The polyimide film was practically the same as the film of the polyimide 4.

[Evaluation of Dynamic Viscoelasticity]

The dynamic viscoelasticity of the formed film in the evaluation of thermophysical properties was measured at a frequency of 3 Hz and a temperature rise rate of 5° C./min with the use of the viscoelasticity measurement device (Solid Analyzer RSA II; manufactured by Rheometric Scientific Corporation).

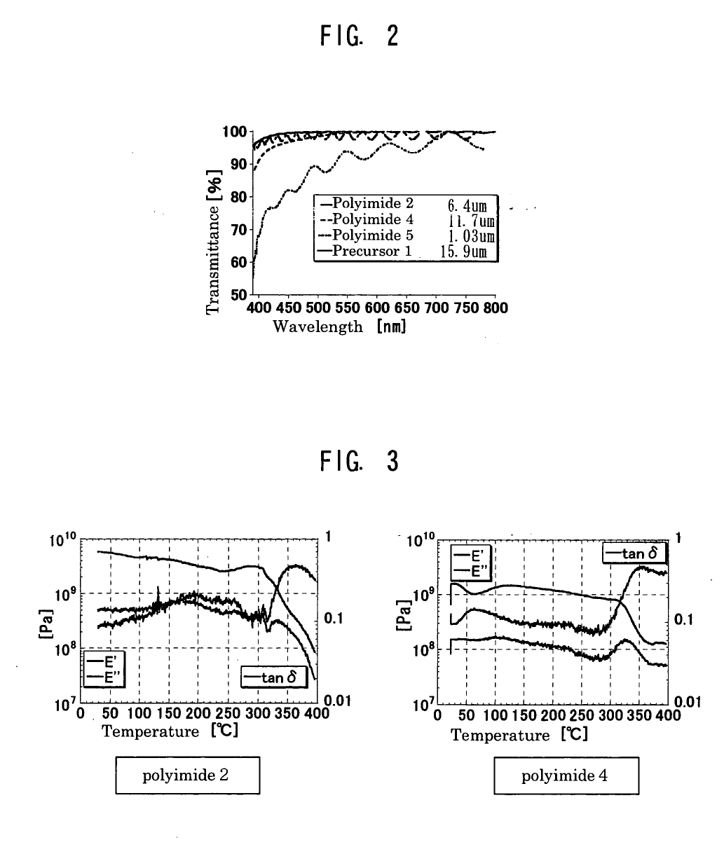

The measured results of each film of the polyimide 2 and the polyimide 4 are shown in FIG. 3. As both of the polyimide have the peak of tan 6 at around 350° C., Tg (glass transition temperature) of each polyimide was 350° C. Moreover, from the behavior of storage modulus (E′) and loss modulus (E″) of Tg or more, as the polyimide 4 had a rubbery region (an area in which E′ and E″ are constant between a certain temperature and a certain temperature) at Tg or more, it is implied that the polyimide 4 is a cross-linking agent. On the other hand, it is implied that the polyimide 2 is not a cross-linking agent as E′ and E″ decrease at Tg or more.

[Evaluation of Coefficient of Linear Thermal Expansion]

The linear thermal expansion of the film formed in the evaluation of thermophysical properties was measured by the thermomechanical analysis device (Thermo Plus TMA8310; manufactured by Rigaku Corporation) at a temperature rise rate of 10° C./min under the condition of 1 g of a tensile load for a film of the polyimide 2 and 5 g of tensile load for a film of the polyimide 4 (about 1 g per 5 μm of thickness).

As a result, the coefficient of linear thermal expansion of the polyimide 2 was 27 ppm and the coefficient of linear thermal expansion of the polyimide 4 was 25 ppm at 50° C. to 100° C. Moreover, an inflection point of the film expansion of each polyimide was 315° C.

According to these results, as the polyimide having a seven-membered ring imide structure of the present invention has excellent heat resistance and high transparency, and may be formed into a film having a low expansion ratio, it is suitable for forming products of fields in which these characteristics are advantageous, for example, paints, printing inks, color filters, flexible display films, electronic parts, layer insulation films, wire cover films, optical circuits, optical circuit parts, antireflection films, holograms, other optical members or building materials.

Further, the polyimide of the present invention is suitable as a film or coating layer for all known members requiring transparency. The polyimide of the present invention is expected to be utilized as a film or structure having high heat resistance for an optical member such as an antireflection film, an optical circuit part, a hologram or the like.

1. A polymer compound comprising a part which sequences an unsaturated bond containing a II electron orbit and a single bond alternately, wherein at least a part of a conjugated state formed by the II electron orbit in a molecule is shortened or weakened due to a three-dimensional structure of the molecule, and wherein a transmittance of at least a part of a wavelength between 400 nm to 800 nm is larger than an expected transmittance provided that the conjugated state is not shortened or weakened.

2. A polymer compound according to claim 1, wherein 50 wt % or more of the whole polymer compound is composed of an aromatic structure, and wherein a transmittance of each wavelength between 400 nm and 800 nm when the polymer compound is made into a film having a thickness of 1 μm is 85% or more.

3. A polymer compound according to claim 1, wherein 50% by mole or more of repeating units constituting a polymer frame of the polymer compound is a repeating unit containing an aromatic ring or a condensed ring containing an aromatic ring to be a part of the polymer frame, and wherein at least a part of a conjugated state between the aromatic rings or the condensed rings to be a part of the polymer frame is shortened or weakened due to a three-dimensional structure of a molecule.

4. A polymer compound according to claim 3, wherein a mole ratio of the three-dimensional structure of a molecule which shortens or weakens the conjugated state is 50% or more with respect to an amount of the repeating unit containing an aromatic ring or a condensed ring containing an aromatic ring to be a part of the polymer frame.

5. A polymer compound according to claim 3, wherein the polymer compound contains a repeating unit containing a condensed ring which contains two or more aromatic rings and constitutes a part of the polymer frame as the repeating unit containing a condensed ring, and wherein a conjugated state at least among two aromatic rings contained in the same condensed ring of the repeating unit is shortened or weakened by a three-dimensional structure of a molecule.

6. A polymer compound according to claim 5, wherein 50% by mole or more of the repeating units constituting the polymer frame is a repeating unit containing the condensed ring having the conjugated state among the aromatic rings shortened or weakened.

7. A polymer compound according to claim 1, wherein a glass transition temperature is 120° C. or more.

8. A polymer compound according to claim 1, wherein a coefficient of linear thermal expansion is 60 ppm or less.

9. A resin composition comprising the polymer compound of claim 1.

10. A resin composition according to claim 9, wherein the resin composition is used as a pattern forming material.

11. A resin composition according to claim 9, wherein the resin composition is used as a forming material of paints or printing inks, color filters, flexible display films, electronic parts, layer insulation films, wire cover films, optical circuits, optical circuit parts, antireflection films holograms, optical members, or building materials.

12. An article comprising a printed matter, a color filter, a flexible display film, an electronic part, a layer insulation film, a wire cover film, an optical circuit, an optical circuit part, an antireflection film, a hologram, an optical member or a building material, at least a part of which is formed by the resin composition of claim 9 or a cured product thereof.

13. A highly transparent polyimide comprising a repeating unit represented by the following formula (1): 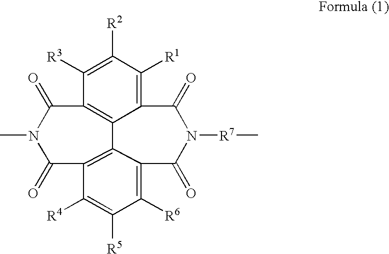
wherein, each of R¹ to R⁶ is independently a hydrogen atom or a monovalent organic group, which may be bonded each other; R⁷ is a divalent organic group; and groups represented by the same symbol among repeating units in the same molecule maybe different atoms or structures.

14. A highly transparent polyimide according to claim 13, further comprising a repeating unit represented by the following formula (2): 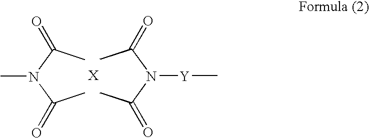
wherein, “X” is a tetravalent organic group; “Y” is a divalent organic group; and groups represented by the same symbol of repeating units in the same molecule may be different atoms or structures.

15. An aromatic seven-membered ring polyimide according to claim 13, wherein a light transmittance of each wavelength between 400 nm and 800 nm when the highly transparent polyimide is made into a film having a thickness of 1 μm is 85% or more.

16. An aromatic seven-membered ring polyimide according to claim 13, wherein a coefficient of linear thermal expansion is 60 ppm or less.

17. An aromatic seven-membered ring polyimide) according to claim 13, wherein a glass transition temperature is 120° C. or more.

18. An aromatic seven-membered ring polyimide according to claim 13, wherein an intramolecular imide cyclization rate is 80% or more.

19. An aromatic seven-membered ring polyimide according to claim 13, wherein the aromatic seven-membered ring polyimide does not show a rubbery region in a dynamic viscoelasticity measurement.

20. An aromatic seven-membered ring polyimide according to claim 13, wherein a weight average molecular weight is 10,000 or more.

21. An highly transparent polyimide according to claim 13, wherein the formula (1) is a repeating unit of the whole aromatic polyimide.

22. A polyimide resin composition comprising polyimide of claim 13.

23. A polyimide resin composition according to claim 22, wherein the polyimide resin composition is used as a pattern forming material.

24. A polyimide resin composition according to claim 22, wherein the polyimide resin composition is used as a forming material of paints or printing inks, color filters, flexible display films, electronic parts, layer insulation films, wire cover films, optical circuits, optical circuit parts, antireflection films holograms, optical members, or building materials.

25. An article comprising a printed matter, a color filter, a flexible display film, an electronic part, a layer insulation film, a wire cover film, an optical circuit, an optical circuit part, an antireflection film, a hologram, an optical member or a building material, at least a part of which is formed by the polyimide resin composition of claim 22 or a cured product thereof.
